(19) United States
(12) Patent Application Publication
(10) Pub. No.: US 2026/0206749 A1
(43) Pub. Date: Jul. 23, 2026

(54) IMPROVED PESTICIDAL COMPOSITIONS

(71) Applicant: SYNGENTA CROP PROTECTION AG, Basel (CH)

(72) Inventors: Filipp KASAKOWSKI, Muenchwilen (CH); Roger KEMP, Muenchwilen (CH); Catherine Julia PIPER, Bracknell, Berkshire (GB)

(73) Assignee: SYNGENTA CROP PROTECTION AG, Basel (CH)

(21) Appl. No.: 19/139,668

(22) PCT Filed: Dec. 14, 2023
(86) PCT No.: PCT/EP2023/085947

§ 371 Date: Jun. 16, 2025

(30) Foreign Application Priority Data
Dec. 16, 2022 (EP) 22214292.9

(51) Int. Cl. A01N 37/18; A01N 25/02; A01P 3/00

(52) U.S. Cl. CPC A01N 37/18; A01N 25/02; A01P 3/00

(57) ABSTRACT

This invention relates to compositions comprising certain (biological performance improving) adjuvants and mandipropamid; and to use of the adjuvants to improve the biological performance of mandipropamid.

The present invention relates to improved pesticidal compositions for controlling or preventing infestation of plants, harvested food crops, seeds or non-living materials by phytopathogenic microorganisms, preferably fungi. More specifically the present invention relates to pesticidal compositions containing mandipropamid.

Mandipropamid (chemical name: 2-(4-chloro-phenyl)-N-[2-(3-methoxy-4-prop-2-ynyloxy-phenyl)-ethyl]-2-prop-2-ynyloxy-acetamide) and its method of manufacture is described in WO01/87822 and WO2007/020381. CN115039776 discloses compositions comprising mandipropamid and various azole fungicides, typically as water based formulations, including a wettable powder (WP), water dispersible granule (WG) or suspension concentrate (SC). CN108294023 discloses compositions comprising mandipropamid and berberine as a suspension concentrate (SC). CN103392739 discloses compositions comprising mandipropamid and copper calcium sulfate, typically as a wettable powder (WP), water dispersible granule (WG) or suspension concentrate (SC). CN105340926 discloses compositions comprising mandipropamid and a polyoxin fungicide, typically as water based formulations, including a wettable powder (WP), water dispersible granule (WG) or suspension concentrate (SC). CN103181393 discloses compositions comprising mandipropamid and propamocarb, typically as water based formulations, including an emulsion in water (EW), wettable powder (WP), water dispersible granule (WG) or suspension concentrate (SC). CN102461501 discloses compositions comprising mandipropamid and cyazofamid, typically as water based formulations, including a wettable powder (WP), water dispersible granule (WG) or suspension concentrate (SC). CN101971813 discloses compositions comprising mandipropamid and azoxystrobin, typically as water based formulations, including a wettable powder (WP), water dispersible granule (WG) or suspension concentrate (SC). CN102461526 discloses compositions comprising mandipropamid and propamocarb, typically as water based formulations, including a wettable powder (WP), water dispersible granule (WG) or suspension concentrate (SC). CN101990895 discloses compositions comprising mandipropamid and kresoxim-methyl or pyraclostrobin, typically as water based formulations, including a wettable powder (WP), water dispersible granule (WG) or suspension concentrate (SC). Mandipropamid is also described in “The Pesticide Manual” Fourteenth Edition, published by BCPC. Mandipropamid is listed as entry 514 and has the chemical formula depicted as formula (1-1) herein:

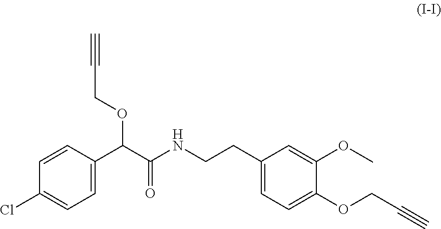 [SMILES: C#CCOc1ccc(CCNC(=O)C(OCC#C)c2ccc(Cl)cc2)cc1OC]

Mandipropamid is known in the art and is commercialized under, amongst others, the brand name REVUS® as a fungicide for the control of late blight caused by Phytopthera infestans in potatoes and downy mildew in a range of vegetable crops.

There remains a need for improved formulations containing mandipropamid which formulations are chemically and physically stable, particularly when stored in concentrated form and then upon subsequent dilution are applicable under typical field conditions whilst maintaining a good biological efficacy. In addition, there remains a need for improved formulations which can demonstrate an enhanced and/or prolonged biological efficacy when used in the field. The present invention is aimed at solving some of the problems that exist in the prior art.

According to the present invention, there is provided a composition comprising,
(i) mandipropamid; and
(ii) one or more adjuvants selected from the group consisting of alcohol alkoxylates, ethylene oxide/propylene oxide block copolymers, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate;
and wherein the composition is an oil dispersion.

Surprisingly, it has been found that the compositions as described herein have, for practical purposes, a very advantageous level of biological activity for protecting plants against diseases that are caused by fungi. Said compositions are also chemically and physically stable, particularly when stored in concentrated form.

According to a second aspect of the invention, there is provided a composition comprising,
(i) mandipropamid; and
(ii) one or more adjuvants selected from the group consisting of C₁₀-C₁₈ alcohol alkoxylates and bis(7-methyloctyl) cyclohexane-1,2-dicarboxylate.

According to a third aspect of the invention, there is provided a method of controlling or preventing infestation of useful plants by phytopathogenic fungi comprising applying a composition according to the invention, to said plants, to parts thereof or the locus thereof.

According to a fourth aspect of the invention, there is provided the use of one or more adjuvants selected from the group consisting of alcohol alkoxylates, ethylene oxide/propylene oxide block copolymers, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate to improve the biological performance of mandipropamid.

As already indicated, surprisingly, it has now been found that the compositions according to the present invention have, for practical purposes, a very advantageous level of biological activity for protecting plants against diseases that are caused by fungi.

Furthermore the compositions according to the present invention may also provide improved wetting or improved spray retention properties.

The compositions according to the invention are primarily used as a fungicide. The term “fungicide” as used herein means a compound that controls, modifies, or prevents the growth of fungi. The term “fungicidally effective amount” as used herein means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection.

Adjuvants (bioperformance enhancing additives) are often added in the tank mix at the point of dilution, however it is preferable and more convenient for the user if the additives are included in the formulation or formulation concentrate. As used herein the term “adjuvant” means a system for enhancing agrochemical bioperformance comprising one or more bio-performance enhancing additives.

As used herein the term “tank-mix” means that the formulation components or additional active ingredients are mixed in the spray tank at the time of spray application.

As used herein the term “built-in” refers to formulation components (for example adjuvants) that are incorporated into the formulation or formulation concentrate.

As used herein the term “active ingredient” refers to pesticidal agents that are referred to using their common name, for example, from “The Pesticide Manual”, 15th Ed., British Crop Protection Council 2009.

As used herein the term “ethylene oxide/propylene oxide block copolymers” refers to adjuvants that include, but are not limited to, tri-block copolymers, such as poly(ethylene oxide)-poly(propylene oxide)-poly(ethylene oxide) block copolymers. Examples include, the Pluronic® series (BASF) and the Synperonic® PE series (e.g Synperonic® PE/L 62) (Croda).

As used herein the term “alcohol alkoxylates” refers to adjuvants that comprise polyethylene oxide and/or polypropyleneoxide and a C₄-C₁₈ straight or branched chain alkyl or alkenyl group, including, but not limited to, Witconol® NS500 (Evonik), Toximul® 8320 (Stepan), Marlox® RT 64 (Sasol), Emulsogen® M (Clariant), Genapol® X 080 (Clariant), Synperonic® L11 (Croda), Atlox® MBA 11/8 (Croda) and Plurafac® LF 300 (BASF).

As used herein the term “polyacrylate polymers” refers to adjuvants that include, but are not limited to, Vinamul® 18460 (Celanese).

As used herein the term “alkyl polyglycosides” refers to adjuvants that include, but are not limited to, Atplus 435® and Agnique® PG-8107-G (BASF).

As used herein the term “alkyl glucamides” refers to adjuvants that include, but are not limited to, Synergen® GA (1-Deoxy-1-(methyl-(C8-10-(even)-alkanoyl)amino)-D-glucitol, CAS-No. 1591782-62-5) (Clariant).

As used herein the term “rapeseed oil methyl ester” refers to carriers that include, but are not limited to, Agnique® ME 18 RD-F (BASF), Adigor® (Syngenta) and STEPOSOL® ROE-W (Stepan).

As used herein the term “ethoxylated sorbitan derivatives” refers to adjuvants that include, but are not limited to, one of the Tween® series of surfactants, for example Tween® 20 which is Ethoxylated (20)-sorbitan monolaurate or Tween® 85 (Croda).

As used herein the term “polyether modified polysiloxanes” refers to adjuvants that include, but are not limited to, di- and trisiloxanes, organosilicones (also known as organomodified silicones) and hydrophilic polysiloxanes such as BREAK-THRU® S-240 (Evonik).

As used herein the term “bis(7-methyloctyl) cyclohexane-1,2-dicarboxylate” refers to adjuvants sold under the trade names Agnique® AE 829 (BASF) and Hexamoll® DINCH (BASF).

As used herein the term “ethoxylated castor oil” refers to emulsifiers that comprise polyethylene glycol esters of fatty acids, including, but not limited to, emulsifiers sold under the trade name ALKAMULS® VO/2005 (Solvay).

As used herein the term “oil dispersion (OD)” refers to a formulation wherein a solid active ingredient (for example mandipropamid) is dispersed in oil (non-aqueous continuous phase).

As used herein the term “suspension concentrate (SC)” refers to a formulation wherein a solid active ingredient (for example mandipropamid) is dispersed in water (aqueous continuous phase).

The adjuvant component in the formulation may be a single adjuvant or a combination of two or more adjuvants (preferably, from one to four adjuvants, more preferably, from one to three adjuvants). The one or more adjuvants (preferably, from one to four adjuvants, more preferably, from one to three adjuvants) are selected from the group consisting of alcohol alkoxylates, ethylene oxide/propylene oxide block copolymers, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate. Preferably, the one or more adjuvants (preferably, from one to four adjuvants, more preferably, from one to three adjuvants) are selected from the group consisting of alcohol alkoxylates, ethylene oxide/propylene oxide block copolymers, sodium dodecylbenzene sulfonate, calcium dodecylbenzene sulfonate, potassium dodecylbenzene sulfonate and bis(7-methyloctyl) cyclohexane-1,2-dicarboxylate. More preferably, the one or more adjuvants (preferably, from one to four adjuvants, more preferably, from one to three adjuvants) are selected from the group consisting of C₁₀-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate. Even more preferably, the one or more adjuvants (preferably, from one to four adjuvants, more preferably, from one to three adjuvants) are selected from the group consisting of C₁₆-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate.

The skilled person would appreciate that the alcohol alkoxylate adjuvants as described herein may be represented by a compound of formula (I),

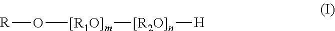

wherein R is a C₄-C₁₈ straight or branched chain alkyl or alkenyl group, R₁ is isopropyl, R₂ is ethyl, m is from 0 to 15 and n is from 1 to 25. This means that each R₁₀ represents a propylene oxide [PO] unit and each R₂₀ represents an ethylene oxide [EO] unit and may also be described as a compound of formula (Ia),

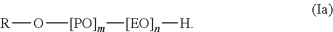

The skilled person would also appreciate that the carbon chain R is such that it can be a blend of different carbon chain lengths.

Preferably, in a compound of formula (I) or (Ia) R is a C₁₀-C₁₈ straight or branched chain alkyl or alkenyl group. More preferably, R is a C₁₆-C₁₈ straight or branched chain alkyl or alkenyl group.

Preferably, in a compound of formula (I) or (Ia) m is from 0 to 10; more preferably from 4 to 9.

Preferably, in a compound of formula (I) or (Ia) n is from 2 to 20; more preferably from 4 to 15.

Preferably, in a compound of formula (I) or (Ia) m is the mean number of PO units.

Preferably, in a compound of formula (I) or (la) n is the mean number of EO units.

The skilled person would appreciate that for a compound of formula (I) wherein m is 0, the alcohol alkoxylate adjuvants may be described as alcohol ethoxylates of formula (II),

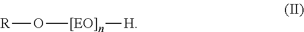

Preferably, in a compound of formula (II) R is a C₁₀-C₁₈ straight or branched chain alkyl or alkenyl group.

Preferably, in a compound of formula (II) n is from 2 to 20; more preferably from 4 to 15.

Preferably, in a compound of formula (II) n is the mean number of EO units.

The skilled person would also appreciate that the alcohol alkoxylate adjuvants as described herein may equally be represented by a compound of formula (III),

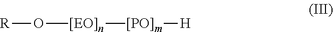

wherein R, n and m are as defined herein.

A preferred group of alcohol alkoxylate adjuvants for use in the compositions of the invention comprise a C₁₀-C₁₈ straight or branched chain alkyl or alkenyl group and from 0 to 10 propylene oxide [PO] and from 2 to 20 ethylene oxide [EO] units. More preferably, the alcohol alkoxylate adjuvants comprise a C₁₀-C₁₈ straight or branched chain alkyl or alkenyl group and from 4 to 9 propylene oxide [PO] and from 4 to 15 ethylene oxide [EO] units. Even more preferably, the alcohol alkoxylate adjuvants comprise a C₁-C₁₈ straight or branched chain alkyl or alkenyl group and from 4 to 9 propylene oxide [PO] and from 4 to 15 ethylene oxide [EO] units.

In one embodiment, the alcohol alkoxylate adjuvants for use in the compositions of the invention are C₁₀-C₁₈ alcohol alkoxylates having the CAS registry numbers 68920-66-1, 68002-96-0, 9043-30-5, 78330-21-9, 127036-24-2 or 68551-12-2.

A preferred group of ethylene oxide/propylene oxide block copolymers for use in the compositions of the invention are poly(ethylene oxide)-poly(propylene oxide)-poly(ethylene oxide) block copolymers having an average molecular weight in a range of from 1,500 to 3,500 gram/mol (preferably, from 2,000 to 3,000 gram/mol, even more preferably from 2,250-2,750 gram/mol). The preferred weight percentage of the poly(ethylene oxide) block as part of the entire block copolymer molecule is in the range of from 10 to 50% (preferably from 15 to 40%, more preferably from 20 to 30%).

The skilled person would appreciate that the alkyl polyglycosides adjuvants as described herein may be represented by a compound of formula (IV),

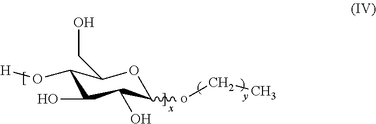

Wherein y is a mean value and is from 7 to 11 (preferably, 7 to 9); and x is a mean value and is from 1 to 3 (preferably, 1 to 2). [y+1 is the mean number of carbon atoms in the hydrophobic tail of the alkyl polyglycoside; and x is the mean number of sugar rings on the hydrophilic head group of the alkyl polyglycoside.] Suitable alkyl polyglycosides according to formula (IV) are Agnique® PG8105 and Agnique® PG8107 having from 8 to 10 tail carbon atoms (y+1) and from 1.5 to 1.7 mean number of sugar rings (x). Preferably the alkyl polyglycoside used in the compositions of the invention has the chemistry of Agnique® PG8107.

The compositions of the present invention may relate to concentrates designed to be added to a farmer's spray tank of water or they may be applied directly without further dilution.

Preferably compositions according to the invention may be selected from an SC (suspension concentrate); an SL (soluble liquid); an EC (emulsifiable concentrate); a DC (dispersible concentrate); a WG (water dispersible granule); a SG (soluble granule); an EW (emulsion in water); a SE (suspension-emulsion); a CS (capsule suspension); and an OD (oil dispersion). More preferably, the composition is a SC (suspension concentrate), a DC (dispersible concentrate), WG (water dispersible granule) or an OD (oil dispersion). Even more preferably, the composition is a SC (suspension concentrate), a DC (dispersible concentrate), or an OD (oil dispersion). Even more preferably still, the composition is a SC (suspension concentrate) or an OD (oil dispersion) Most preferably, the composition is an OD (oil dispersion).

Preferably, in the composition of the invention the mandipropamid:adjuvant w/v ratio is from about 1:0.1 to 1:20. More preferably, the mandipropamid:adjuvant w/v ratio is from about 1:0.1 to 1:10. Even more preferably, the mandipropamid:adjuvant w/v ratio is from about 1:0.3 to 1:5. Yet even more preferably, the mandipropamid:adjuvant w/v ratio is from about 1:0.3 to 1:3. Yet even more preferably still, the mandipropamid:adjuvant w/v ratio is from about 1:0.3 to 1:1.5.

Typically in the compositions of the invention mandipropamid is present at a percentage (%) of from about 0.5% to about 50% w/v (weight/volume) of the total composition; preferably from about 1% to about 40% w/v, more preferably from about 5 to 30% w/v, even more preferably from about 10 to 30% w/v of the total composition.

Typically in the compositions of the invention the adjuvant (or adjuvants) will be present at a percentage (%) of from about 0.5% to about 50% w/v (weight/volume) of the total composition; preferably from about 1% to about 40% w/v, more preferably from about 5 to 30% w/v, even more preferably from about 10 to 30% w/v of the total composition.

The compositions of the present invention may include other ingredients such as a dispersing agent, a surfactant, an emulsifier, a solvent, a polymer, an anti-foam agent, an anti-bacterial agent, a colourant and a perfume, which are well known to the man skilled in the art. Standard formulation publications disclose such formulation components suitable for use with the present invention (for example, Chemistry and Technology of Agrochemical Formulations, Ed. Alan Knowles, published by Kluwer Academic Publishers, The Netherlands in 1998; and Adjuvants and Additives: 2006 Edition by Alan Knowles, Agrow Report DS256, published by Informa UK Ltd, December 2006). The compositions may also comprise other ingredients for improving formulation compatibility; such as hydrotropes and viscosity reducing aids, as discussed in WO12052545, which may be suitable for use with the composition of the present invention.

Typically in the compositions of the invention each additional formulation ingredient will be present at a percentage (%) of from 0.001% to 15% w/v, preferably from about 0.01% to about 10% w/v, more preferably from about 0.01% to about 6% w/v of the total composition.

Suitable agricultural carriers that are useful in formulating the compositions of the invention in the formulation types described above are well known to those skilled in the art.

Liquid carriers that can be employed include, for example, water, vegetable and/or animal oil based derivatives (including but not limited to, olive oil, soybean oil, sunflower oil, castor oil, seasame oil, corn oil, groundnut oil, rapeseed oil, linseed oil, almond oil, sunflower oil, beef tallow oil, sperm oil, hering oil, castor oil and derivatives thereof), toluene, xylene, petroleum naphtha, crop oil, acetone, methyl ethyl ketone, cyclohexanone, acetic anhydride, acetonitrile, acetophenone, amyl acetate, 2-butanone, chlorobenzene, cyclohexane, cyclohexanol, alkyl acetates, diacetonalcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethyl formamide, dimethyl sulfoxide, 1,4-dioxane, dipropylene glycol, dipropylene glycol methyl ether, dipropylene glycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octyl amine acetate, oleic acid, oleylamine, o-xylene, phenol, polyethylene glycol (PEG400), propionic acid, propylene glycol, propylene glycol monomethyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, methanol, ethanol, isopropanol, and higher molecular weight alcohols such as amyl alcohol, tetrahydrofurfuryl alcohol, hexanol, octanol, etc., ethylene glycol, propylene glycol, glycerine and N-methyl-2-pyrrolidinone. In the compositions of the invention the preferred agrochemically-acceptable diluent or carrier is a vegetable oil or water. Preferably, the vegetable oil is an alkyl ester (preferably C₁-C₆alkyl). More preferably, the alkyl ester of vegetable oils is selected from the group consisting of rapeseed oil methyl ester, rapeseed oil ethyl ester, rapeseed oil propyl esters, rapeseed oil butyl esters, and tall oil fatty acids esters. Even more preferably, the alkyl ester of vegetable oils is rapeseed oil methyl ester or rapeseed oil ethyl ester. Most preferably, the alkyl ester of vegetable oils is rapeseed oil methyl ester.

Suitable solid carriers include, for example, talc, titanium dioxide, pyrophyllite clay, silica, attapulgite clay, kieselguhr, chalk, diatomaxeous earth, lime, calcium carbonate, bentonite clay, fuller's earth, cotton seed hulls, wheat flour, soybean flour, pumice, wood flour, walnut shell flour and lignin.

In addition, further, other biocidally active ingredients or compositions may be combined with the compositions of the invention and used in the methods of the invention and applied simultaneously or sequentially with the compositions of the invention. When applied simultaneously, these further active ingredients may be formulated together with the compositions of the invention or mixed in, for example, the spray tank. These further biocidally active ingredients may be fungicides, herbicides, insecticides, bactericides, acaricides, nematicides and/or plant growth regulators.

Pesticidal agents are referred to herein using their common name are known, for example, from “The Pesticide Manual”, 15th Ed., British Crop Protection Council 2009.

In addition, the compositions of the invention may also be applied with one or more systemically acquired resistance inducers (“SAR” inducer). SAR inducers are known and described in, for example, U.S. Pat. No. 6,919,298 and include, for example, salicylates and the commercial SAR inducer acibenzolar-S-methyl.

Preferably, there is provided a composition comprising,
(i) mandipropamid; and
(ii) one or more adjuvants selected from the group consisting of alcohol alkoxylates, ethylene oxide/propylene oxide block copolymers, sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

More preferably, there is provided a composition comprising,
(i) mandipropamid (preferably where the mandipropamid is the only active ingredient in the composition); and
(ii) one or more adjuvants selected from the group consisting of C₄-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

Even more preferably, there is provided a composition comprising,
(i) mandipropamid (preferably where the mandipropamid is the only active ingredient in the composition); and
(ii) one or more adjuvants selected from the group consisting of C₁₀-C₁₈ alcohol alkoxylates (preferably comprising a C₁₀-C₁₈ straight or branched chain alkyl or alkenyl group and from 0 to 10 propylene oxide [PO] and from 2 to 20 ethylene oxide [EO] units), sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

Yet even more preferably, there is provided a composition comprising,
(i) mandipropamid (preferably where the mandipropamid is the only active ingredient in the composition); and
(ii) one or more adjuvants selected from the group consisting of C₁₀-C₁₈ alcohol alkoxylates comprising a C₁₀-C₁₈ straight or branched chain alkyl or alkenyl group and from 4 to 9 propylene oxide [PO] and from 4 to 15 ethylene oxide [EO] units, sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

Yet even more preferably still, there is provided a composition comprising,
(i) mandipropamid (preferably where the mandipropamid is the only active ingredient in the composition); and
(ii) one or more adjuvants selected from the group consisting of C₁₆-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

Furthermore preferably still, there is provided a composition comprising,
(i) mandipropamid (preferably where the mandipropamid is the only active ingredient in the composition); and
(ii) one or more adjuvants selected from the group consisting of a C₁₆-C₁₈ alcohol alkoxylate comprising a straight or branched chain alkyl or alkenyl group and from 4 to 9 propylene oxide [PO] and from 4 to 15 ethylene oxide [EO] units, sodium dodecylbenzene sulfonate, calcium dodecylbenzene sulfonate, potassium dodecylbenzene sulfonate and bis(7-methyloctyl) cyclohexane-1,2-dicarboxylate,
and wherein the composition is an oil dispersion (preferably, wherein the one or more adjuvants are built-in to the composition).

In one embodiment of the invention there is provided a composition comprising,
(i) mandipropamid (preferably where the mandipropamid is the only active ingredient in the composition); and
(ii) one or more adjuvants selected from the group consisting of C₁₀-C₁₈ alcohol alkoxylates and bis(7-methyloctyl) cyclohexane-1,2-dicarboxylate.

Preferably in this embodiment of the invention there is provided a composition comprising,
(i) mandipropamid (preferably where the mandipropamid is the only active ingredient in the composition); and
(ii) one or more adjuvants selected from the group consisting of C₁₀-C₁₈ alcohol alkoxylates and bis(7-methyloctyl) cyclohexane-1,2-dicarboxylate, wherein the C₁₀-C₁₈ alcohol alkoxylate comprises a straight or branched chain alkyl or alkenyl group and from 0 to 10 propylene oxide [PO] and from 2 to 20 ethylene oxide [EO] units.

More preferably, in this embodiment of the invention there is provided a composition comprising,
(i) mandipropamid (preferably where the mandipropamid is the only active ingredient in the composition); and
(ii) one or more adjuvants selected from the group consisting of C₁₀-C₁₈ alcohol alkoxylates and bis(7-methyloctyl) cyclohexane-1,2-dicarboxylate, wherein the C₁₀-C₁₈ alcohol alkoxylates have the CAS registry numbers 68920-66-1, 68002-96-0, 9043-30-5, 78330-21-9, 127036-24-2 or 68551-12-2.

In another embodiment of the invention there is provided a composition (preferably, wherein the composition is an oil dispersion more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate.

Preferably in this embodiment of the invention there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₄-C₁₈ straight or branched chain alkyl or alkenyl group.

More preferably, in this embodiment there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₄-C₁₈ straight or branched chain alkyl or alkenyl group and from 0 to 10 propylene oxide [PO] and from 2 to 20 ethylene oxide [EO] units.

Even more preferably, in this embodiment there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₀-C₁₈ straight or branched chain alkyl or alkenyl group and from 0 to 10 propylene oxide [PO] and from 2 to 20 ethylene oxide [EO] units.

Yet even more preferably, in this embodiment there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 0 to 10 propylene oxide [PO] and from 4 to 15 ethylene oxide [EO] units.

Yet further more preferably in this embodiment, there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 4 to 9 propylene oxide [PO] and from 4 to 15 ethylene oxide [EO] units.

In another embodiment, there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another preferred embodiment, there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₄-C₁₈ straight or branched chain alkyl or alkenyl group,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another preferred embodiment there is provided a composition (preferably, wherein the composition is an oil dispersion more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₄-C₁₈ straight or branched chain alkyl or alkenyl group and from 0 to 10 propylene oxide [PO] and from 2 to 20 ethylene oxide [EO] units,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another preferred embodiment there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₀-C₁₈ straight or branched chain alkyl or alkenyl group and from 0 to 10 propylene oxide [PO] and from 2 to 20 ethylene oxide [EO] units,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another preferred embodiment there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 0 to 10 propylene oxide [PO] and from 4 to 15 ethylene oxide [EO] units,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another preferred embodiment, there is provided a composition (preferably, wherein the composition is an oil dispersion, more preferably, wherein the oil is a vegetable oil, even more preferably an alkyl ester of vegetable oils, even more preferably still an alkyl ester of vegetable oils selected from the group consisting of rapeseed oil methyl ester, rapeseed oil ethyl ester, rapeseed oil propyl esters, rapeseed oil butyl esters, and tall oil fatty acids esters, yet even more preferably still, rapeseed oil methyl ester or rapeseed oil ethyl ester, most preferably, rapeseed oil methyl ester) comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 4 to 9 propylene oxide [PO] and from 4 to 15 ethylene oxide [EO] units,
wherein mandipropamid is present at a percentage (%) of from about 0.5% to about 50% w/v (weight/volume) of the total composition and the alcohol alkoxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the alcohol alkoxylate is present at a percentage (%) of from about 1% to about 40% w/v (weight/volume) of the total composition. More preferably, mandipropamid is present at a percentage (%) of from about 5% to about 30% w/v (weight/volume) of the total composition and the alcohol alkoxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the alcohol alkoxylate is present at a percentage (%) of from about 10% to about 30% w/v (weight/volume) of the total composition.

In another embodiment of the invention there is provided a composition comprising,
(i) mandipropamid (preferably where the mandipropamid is the only active ingredient in the composition); and
(ii) an ethylene oxide/propylene oxide block copolymer.

Preferably in this embodiment of the invention there is provided a composition comprising,
(i) mandipropamid (preferably where the mandipropamid is the only active ingredient in the composition); and
(ii) an ethylene oxide/propylene oxide block copolymer having an average molecular weight in a range of from 1,500 to 3,500 gram/mol (preferably, from 2,000 to 3,000 gram/mol).

More preferably, in this embodiment of the invention there is provided a composition comprising,
(i) mandipropamid (preferably where the mandipropamid is the only active ingredient in the composition); and
(ii) an ethylene oxide/propylene oxide block copolymer having an average molecular weight in a range of from 2,000 to 3,000 gram/mol and wherein the weight percentage of the poly(ethylene oxide) block as part of the entire block copolymer molecule is in the range of from 10 to 50% (preferably from 20 to 40%).

In another embodiment of the invention there is provided a composition comprising,
(i) mandipropamid (preferably where the mandipropamid is the only active ingredient in the composition); and
(ii) a polyacrylate polymer. Preferably an acrylic graft copolymer, more preferably an acrylic graft copolymer with an HLB (Hydrophilic-lipophilic balance) value of 10-13 (preferably 12).

In another embodiment of the invention there is provided a composition comprising,
(i) mandipropamid (preferably where the mandipropamid is the only active ingredient in the composition); and
(ii) an alkyl polyglycoside (preferably a C₈-C₁₀alkyl polyglycoside).

In another embodiment of the invention there is provided a composition comprising,
(i) mandipropamid (preferably where the mandipropamid is the only active ingredient in the composition); and
(ii) an alkyl polyglycoside of formula (IV),

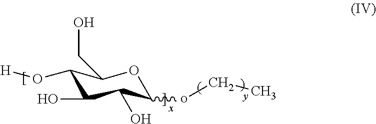

wherein y is a mean value and is from 7 to 11 (preferably, 7 to 9); and x is a mean value and is from 1 to 3 (preferably, 1 to 2).

In another embodiment of the invention there is provided a composition comprising,
(i) mandipropamid (preferably where the mandipropamid is the only active ingredient in the composition); and
(ii) an alkyl glucamide. Preferably the alkyl glucamide is a C₈-C₁₀alkyl glucamide.

In another embodiment of the invention there is provided a composition comprising,
(i) mandipropamid (preferably where the mandipropamid is the only active ingredient in the composition); and
(ii) an ethoxylated sorbitan derivative. Preferably the ethoxylated sorbitan derivative is a polyoxyethylene sorbitan trioleate comprising from 15-25 EO units (preferably 20 EO units).

In another embodiment of the invention there is provided a composition comprising,
(i) mandipropamid (preferably where the mandipropamid is the only active ingredient in the composition); and
(ii) a polyether modified polysiloxane.

In another embodiment of the invention there is provided a composition comprising,
(i) mandipropamid (preferably where the mandipropamid is the only active ingredient in the composition); and
(ii) sodium dodecylbenzene sulfonate and/or calcium dodecylbenzene sulfonate and/or potassium dodecylbenzene sulfonate.

In another embodiment of the invention there is provided a composition comprising,
(i) mandipropamid (preferably where the mandipropamid is the only active ingredient in the composition); and
(ii) tris(2-ethylhexyl) phosphate.

In another embodiment of the invention there is provided a composition comprising,
(i) mandipropamid (preferably where the mandipropamid is the only active ingredient in the composition); and
(ii) bis(7-methyloctyl) cyclohexane-1,2-dicarboxylate.

In another preferred embodiment of the invention there is provided a composition comprising,
(i) mandipropamid (preferably where the mandipropamid is the only active ingredient in the composition); and
(ii) bis(7-methyloctyl) cyclohexane-1,2-dicarboxylate,
wherein mandipropamid is present at a percentage (%) of from about 0.5% to about 50% w/v (weight/volume) of the total composition and the bis(7-methyloctyl) cyclohexane-1,2-dicarboxylate is present at a percentage (%) of from about 0.5% to about 50% w/v (weight/volume) of the total composition. Preferably, mandipropamid is present at a percentage (%) of from about 1% to about 40% w/v (weight/volume) of the total composition and the bis(7-methyloctyl) cyclohexane-1,2-dicarboxylate is present at a percentage (%) of from about 1% to about 40% w/v (weight/volume) of the total composition. More preferably, mandipropamid is present at a percentage (%) of from about 5% to about 30% w/v (weight/volume) of the total composition and the bis(7-methyloctyl) cyclohexane-1,2-dicarboxylate is present at a percentage (%) of from about 5% to about 30% w/v (weight/volume) of the total composition. Even more preferably, mandipropamid is present at a percentage (%) of from about 10% to about 30% w/v (weight/volume) of the total composition and the bis(7-methyloctyl) cyclohexane-1,2-dicarboxylate is present at a percentage (%) of from about 10% to about 30% w/v (weight/volume) of the total composition.

In another embodiment of the invention there is provided a composition comprising,
(i) mandipropamid (preferably where the mandipropamid is the only active ingredient in the composition);
(ii) at least one alcohol alkoxylate comprising a C₄-C₁₈ straight or branched chain alkyl or alkenyl group; and
(iii) a dodecylbenzene sulfonate selected from the group consisting of sodium dodecylbenzene sulfonate, calcium dodecylbenzene sulfonate and potassium dodecylbenzene sulfonate.

More preferably, in this embodiment there is provided a composition comprising,
(i) mandipropamid (preferably where the mandipropamid is the only active ingredient in the composition);
(ii) at least one alcohol alkoxylate comprising a C₄-C₁₈ straight or branched chain alkyl or alkenyl group and from 0 to 10 propylene oxide [PO] and from 2 to 20 ethylene oxide [EO] units; and
(iii) sodium dodecylbenzene sulfonate or calcium dodecylbenzene sulfonate.

Even more preferably, in this embodiment there is provided a composition comprising,
(i) mandipropamid (preferably where the mandipropamid is the only active ingredient in the composition); and
(ii) at least one alcohol alkoxylate comprising a C₁₀-C₁₈ straight or branched chain alkyl or alkenyl group and from 0 to 10 propylene oxide [PO] and from 2 to 20 ethylene oxide [EO] units; and
(iii) sodium dodecylbenzene sulfonate or calcium dodecylbenzene sulfonate.

Yet even more preferably, in this embodiment there is provided a composition comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 0 to 10 propylene oxide [PO] and from 4 to 15 ethylene oxide [EO] units; and
(iii) sodium dodecylbenzene sulfonate or calcium dodecylbenzene sulfonate.

Yet further more preferably in this embodiment, there is provided a composition comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 4 to 9 propylene oxide [PO] and from 4 to 15 ethylene oxide [EO] units; and
(iii) calcium dodecylbenzene sulfonate.

In another embodiment of the invention there is provided a composition comprising,
(i) mandipropamid (preferably where the mandipropamid is the only active ingredient in the composition); and
(ii) an alcohol alkoxylate comprising a C₁₆-C₁₈ straight or branched chain alkyl or alkenyl group and from 0 to 10 propylene oxide [PO] and from 4 to 15 ethylene oxide [EO] units;
(iii) sodium dodecylbenzene sulfonate or calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units.

Preferably, in this embodiment, there is provided a composition comprising,
(i) mandipropamid (preferably where the mandipropamid is the only active ingredient in the composition); and
(ii) an alcohol alkoxylate comprising a C₁₆-C₁₈ straight or branched chain alkyl or alkenyl group and from 4 to 9 propylene oxide [PO] and from 4 to 15 ethylene oxide [EO] units;
(iii) calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units.

In another embodiment of the invention there is provided a composition comprising,
(i) mandipropamid (preferably where the mandipropamid is the only active ingredient in the composition); and
(ii) bis(7-methyloctyl) cyclohexane-1,2-dicarboxylate;
(iii) sodium dodecylbenzene sulfonate or calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units.

Preferably, in this embodiment, there is provided a composition comprising,
(i) mandipropamid (preferably where the mandipropamid is the only active ingredient in the composition); and
(ii) bis(7-methyloctyl) cyclohexane-1,2-dicarboxylate;
(iii) calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units.

In another preferred embodiment of the invention there is provided a composition comprising,
(i) mandipropamid (preferably where the mandipropamid is the only active ingredient in the composition);
(ii) at least one alcohol alkoxylate comprising a C₄-C₁₈ straight or branched chain alkyl or alkenyl group; and
(iii) a dodecylbenzene sulfonate selected from the group consisting of sodium dodecylbenzene sulfonate, calcium dodecylbenzene sulfonate and potassium dodecylbenzene sulfonate,
and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

More preferably, in this embodiment there is provided a composition comprising,
(i) mandipropamid (preferably where the mandipropamid is the only active ingredient in the composition);
(ii) at least one alcohol alkoxylate comprising a C₄-C₁₈ straight or branched chain alkyl or alkenyl group and from 0 to 10 propylene oxide [PO] and from 2 to 20 ethylene oxide [EO] units; and
(iii) sodium dodecylbenzene sulfonate or calcium dodecylbenzene sulfonate, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

Even more preferably, in this embodiment there is provided a composition comprising,
(i) mandipropamid (preferably where the mandipropamid is the only active ingredient in the composition); and
(ii) at least one alcohol alkoxylate comprising a C₁₀-C₁₈ straight or branched chain alkyl or alkenyl group and from 0 to 10 propylene oxide [PO] and from 2 to 20 ethylene oxide [EO] units; and
(iii) sodium dodecylbenzene sulfonate or calcium dodecylbenzene sulfonate, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

Yet even more preferably, in this embodiment there is provided a composition comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 0 to 10 propylene oxide [PO] and from 4 to 15 ethylene oxide [EO] units; and
(iii) sodium dodecylbenzene sulfonate or calcium dodecylbenzene sulfonate, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

Yet further more preferably in this embodiment, there is provided a composition comprising,
(i) mandipropamid (preferably where the mandipropamid is the only active ingredient in the composition); and
(ii) at least one alcohol alkoxylate comprising a C₁₆-C₁₈ straight or branched chain alkyl or alkenyl group and from 4 to 9 propylene oxide [PO] and from 4 to 15 ethylene oxide [EO] units; and
(iii) calcium dodecylbenzene sulfonate, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

In another embodiment of the invention there is provided a composition comprising,
(i) mandipropamid (preferably where the mandipropamid is the only active ingredient in the composition); and
(ii) an alcohol alkoxylate comprising a C₁₆-C₁₈ straight or branched chain alkyl or alkenyl group and from 0 to 10 propylene oxide [PO] and from 4 to 15 ethylene oxide [EO] units;
(iii) sodium dodecylbenzene sulfonate or calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

Preferably, in this embodiment, there is provided a composition comprising,
(i) mandipropamid (preferably where the mandipropamid is the only active ingredient in the composition); and
(ii) an alcohol alkoxylate comprising a C₁₆-C₁₈ straight or branched chain alkyl or alkenyl group and from 4 to 9 propylene oxide [PO] and from 4 to 15 ethylene oxide [EO] units;
(iii) calcium dodecylbenzene sulfonate; and
(iv) an alcohol alkoxylate comprising a C₁₀-C₁₄ straight or branched chain alkyl or alkenyl group and 0 propylene oxide [PO] and from 4 to 15 ethylene oxide [EO] units, and wherein the composition is an oil dispersion (preferably, wherein the one or more adjuvants are built-in to the composition and wherein the oil is a vegetable oil, more preferably an alkyl ester of vegetable oils, even more preferably an alkyl ester of vegetable oils selected from the group consisting of rapeseed oil methyl ester, rapeseed oil ethyl ester, rapeseed oil propyl esters, rapeseed oil butyl esters, and tall oil fatty acids esters, even more preferably still, rapeseed oil methyl ester or rapeseed oil ethyl ester, most preferably, rapeseed oil methyl ester).

The present invention further relates to the use of one or more adjuvants selected from the group consisting of ethylene oxide/propylene oxide block copolymers, alcohol alkoxylates, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). Preferably, there is provided the use of one or more adjuvants selected from the group consisting of alcohol alkoxylates, ethylene oxide/propylene oxide block copolymers, sodium dodecylbenzene sulfonate, calcium dodecylbenzene sulfonate, potassium dodecylbenzene sulfonate and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). More preferably, there is provided the use of one or more adjuvants selected from the group consisting of C₄-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). Even more preferably, there is provided the use of one or more adjuvants selected from the group consisting of C₁₀-C₁₈ alcohol alkoxylates and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). Even more preferably still there is provided the use of one or more adjuvants selected from the group consisting of C₁₆-C₁₈ alcohol alkoxylates and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). Yet even more preferably still there is provided the use of one or more adjuvants selected from the group consisting of a C₁₆-C₁₈ alcohol alkoxylate comprising a straight or branched chain alkyl or alkenyl group and from 4 to 9 propylene oxide [PO] and from 4 to 15 ethylene oxide [EO] units, and bis(7-methyloctyl) cyclohexane-1,2-dicarboxylate to improve the biological performance of mandipropamid (preferably wherein, the mandipropamid:adjuvant w/v ratio is from about 1:0.1 to 1:10, more preferably, from about 1:0.3 to 1:5, even more preferably, from about 1:0.3 to 1:3 and even more preferably still, from about 1:0.3 to 1:1.5). The present invention further relates to methods of controlling or preventing infestation of useful plants or plant propagation material and/or harvested food crops by phytopathogenic fungi comprising applying a composition as described herein, to said plants or plant propagation material and/or harvested food crops, to parts thereof or the locus thereof. Preferably, the invention relates to a method of controlling or preventing infestation of useful plants by phytopathogenic fungi comprising applying a composition as described herein, to said plants, to parts thereof or the locus thereof.

The compositions of the invention may be used for controlling a broad spectrum of plant diseases, such as foliar and/or soil-borne pathogens of ornamental, turf, vegetable, field, cereal, and fruit crops. These pathogens may include:

Oomycetes, including Phytophthora species such as Phytophthora cactorum, Phytophthora capsici, Phytophthora cinnamomi, Phytophthora citricola, Phytophthora citrophthora, Phytophthora cryptogea, Phytophthora erythroseptica, Phytophthora fragariae, Phytophthora infestans, Phytophthora nicotianae, Phytophthora porri, and Phytophthora sojae; Pythium species such as Pythium aphanidermatum, Pythium arrhenomanes, Pythium graminicola, Pythium irregulare and Pythium ultimum; other Peronosporales such as Bremia lactucae, Hyaloperonospora parasitica, Hyaloperonospora brassicae, Sclerophthora macrospora, Sclerospora graminicola; Peronospora species including Peronospora destructor, Peronospora farinosa f. sp. spinaciae and Peronospora viciae f. sp. pisi; Plasmopara species including Plasmopara halstedii and Plasmopara viticola; Pseudoperonospora species including Pseudoperonospora cubensis and Pseudoperonospora humili; Peronosclerospora species including Peronosclerospora maydis, Peronosclerospora philippinensis and Peronosclerospora sorghi; Albuginales such as Albugo candida, Albugo occidentalis, and Albugo tragopogonis; and Saprolegniales such as Aphanomyces species, including Aphanomyces cochliodes.
Ascomycetes, including Mycosphaerellales such as Actinothyrium graminis, Asperisporium caricae, Cercospora species including Cercospora arachidicola, Cercospora beticola, Cercospora brassicicola, Cercospora canescens, Cercospora cf. flagellaris, Cercospora janseana, Cercospora kikuchii, Cercospora lagenariae, Cercospora sojinae, Cercospora sorghi, Cercospora zeae-maydis; Dothistroma septosporum, Fulvia fulva, Mycosphaerella species including Mycosphaerella pomi and Mycosphaerella linicola; Neopseudocercosporella brassicae, Neopseudocercosporella capsellae, Nothopassalora personata, Nothophaeocrytopus gaeumannii, Passalora bataticola, Passalora koepkei, Pseudocercospora griseola, Pseudocercospora musaei, Pseudocercospora vitis, Pseudocercospora fijiensis, Ramularia species including Ramularia beticola and Ramularia collo-cygni; Ramulariopsis gossypii, Ramulariopsis pseudoglycines, Ramulispora sorghi, Scolecostigmina palmivora, Septoria species including Septoria apiicola, Septoria glycines and Septoria lycopersici; Zasmidium citri-griseum, and Zymosepotria tritici; Helotiales such as Blumeriella jaapii, Botrytis species including Botrytis cinerea, Botrytis aclada and Botrytis fabae; Botryotinia squamosa, Cadophora gregata, Civorinia allii, Claireedia homoeocarpa, Diplocarpon coronariae, Diplocarpon rosae, Drepanopeziza campestris, Gloeotinia temulenta, Hymenoscyphus fraxineus, Leptotrochila medicaginis, Marssonina graminicola, Monilinia species including Monilinia fructicola, Monilinia fructigena and Monilinia laxa; Neofabraea perennans, Neofabraea vagabunda, Oculimacula yallundae, Pezicula spp., Pseudopeziza medicaginis, Pseudopeziza tracheiphila, Pyrenopeziza species including Pyrenopeziza brassicae; Rhabdocline pseudotsugae, Rhynchosporium species including Rhynchosporium secalis; Sclerotinia species including Sclerotinia minor, Sclerotinia borealis and Sclerotinia sclerotiorum; Hypocreales such as Acremonium strictum, Albifimbria verrucaria, Claviceps africana, Claviceps purpurea, Fusarium species including Fusarium avenaceum, Fusarium culmorum, Fusarium fujikuroi, Fusarium graminearum, Fusarium incarnatum, Fusarium langsethiae, Fusarium moniliforme, Fusarium oxysporum, Fusarium oxysporum f.sp. cubense, Fusarium poae, Fusarium proliferatum, Fusarium pseudograminearum, Fusarium subglutinans, Fusarium sulphureum, Fusarium tricinctum, Fusarium virguliforme and Fusarium verticillioides; Gliocladium spp., Neocosmospora phaseoli, Neocosmospora solani, Neonectria candida, Paramyrothecium roridum, Sarocladium oryzae, Trichoderma species including Trichoderma harzianum, Trichoderma pseudokoningii and Trichoderma viride; Trichothecium roseum and Ustilaginoidea virens; Magnaporthales such as Gaeumannomyces avenae, Gaeumannomyces graminis, Gaeumannomyces graminis tritici, Gaeumannomyces wongoonoo, Magnaporthiopsis poae, Pyricularia species including Pyricularia grisea and Pyricularia oryzae; Pleosporales, such as Alternaria species including Alternaria allii, Alternaria alternata, Alternaria arachidis, Alternaria brassicae, Alternaria brassicicola, Alternaria citri, Alternaria dauci, Alternaria grandisi, Alternaria helianthicola, Alternaria linariae, Alternaria mali, Alternaria porri, Alternaria solani and Alternaria tomato; Boeremia coffeae, Ascochyta species including Ascochyta pisi and Ascochyta rabiei; Bipolaris maydis, Bipolaris oryzae, Bipolaris sorokiniana, Cochliobolus spp., Corynespora cassiicola, Curvularia species including Curvularia australiensis, Curvularia cactivora and Curvularia lunata; Didymella species including Didymella pinodella and Didymella pinodes; Xenodidymella applanata, Drechslera species including Drechslera glycines; Epicoccum nigrum, Exserohilum turcicum, Helminthosporium species including Helminthosporium solani; Hendersonia creberrima, Leptosphaerulina crassiasca, Neocamarosporium betae, Ophiosphaerella agrostidis, Ophiosphaerella herpotricha, Ophiosphaerella korrae, Ophiosphaerella narmari, Parastagonospora nodorum, Phaeosphaeria herpotrichoides, Phaeosphaeria maydis, Phoma spp., Plenodomus lindquistii, Plenodomus lingam, Pleospora spp., Pseudopyrenochaeta lycopersici, Pyrenophora species including Pyrenophora poae, Pyrenophora teres and Pyrenophora tritici-repentis; Remotididymella destructiva, Stagonospora tainanensis, Stagonosporopsis cucurbitacearum, Stemphylium species including Stemphylium botryosum, Stemphylium solani and Stemphylium vesicarium; Diaporthales such as Anisogramma anonmala, Apiognomonia errabunda, Cytospora platani, Diaporthe species including Diaporthe amygdali, Diaporthe helianthin, Diaporthe neoviticola and Diaporthe phaseolorum; Dicarpella spp., Discula destructiva, Gnomoniopsis fructicola, Greeneria uvicola, Juglanconis juglandina, Ophiognomonia clavigignenti-juglandacearum, Stenocarpella maydis and Tubakia dryina; Dothideales such as Aureobasidium species including Aureobasidium pullulans; Discosphaerina fulvida; Erysiphales such as Blumeria graminis, Brasiliomyces malachrae, Erysiphe species including Erysiphe betae, Erysiphe cruciferarum, Erysiphe diffusa, Erysiphe heraclei, Erysiphe necator and Erysiphe pisi; Golovinomyces cichoracearum, Golovinomyces orontii, Leveillula taurica, Oidium arachidisi, Oidium neolycoperisci, Phyllactinia guttata, Podosphaera species including Pososphaera aphanis, Podosphaera fuliginea, Podosphaera fusca, Podosphaera leucotricha, Podosphaera macularis, Podosphaera mors-uvae, Podosphaera pannosa, Podosphaera tridactyla and Podosphaera xanthii; Glomerellales such as Colletotrichum species including Colletotrichum acutatum, Colletotrichum cereale, Colletotrichum chrysanthemi, Colletotrichum cliviicola, Colletotrichum coccodes, Colletotrichum fragariae, Colletotrichum gloeosporioides, Colletotrichum graminicola, Colletotrichum lentis, Colletotrichum lindemuthianum, Colletotrichum musae, Colletotrichum orbiculare, Colletotrichum siamense and Colletotrichum truncatum; Glomerella cingluata, Glomerella gossypii, Musicillium theobromae, Plectosphaerella cucumerina, Verticillium species including Verticillium dahliae; Venturiales such as Venturia species including Venturia carpophila, Venturia effusa, Venturia inaequalis, Venturia oleaginea, and Venturia pyrina; Xylariales such as Eutypa lata, Microdochium albescens, Microdochium majus, Microdochium nivale, Microdochium paspali, Microdochium sorghi, Physalospora abdita, Rosellinia spp. and Seimatosporium mariae; Botryosphaeriales such as Botryosphaeria species including Botryosphaeria dothidea; Diplodia species including Diplodia seriata; Dothiorella aromatica, Lasiodiplodia theobromae, Macrophoma theicola, Macrophomina phaseolina, Phyllosticta ampelicida and Phyllosticta cucurbitacearum; Eurotiales such as Aspergillus species including Aspergillus flavus, Aspergillus fumigatus, Aspergillus nidulans, Aspergillus niger and Aspergillus terreus; Penicillium species including Penicillium digitatum, Penicillium expansum and Penicillium italicum; Microascales such as Berkeleyomyces basicola, Thielaviopsis paradoxa, Ceratocystis species including Ceratocystis fimbriata, Ceratocystis manginecans and Ceratocystis platani; Scedosporium species including Scedosporium apiospermum and Scedosporium prolificans; Myriangiales such as Elsinoe species including Elsinoe ampelina and Elsinoe perseae; Ophiostomatales such as Leptographium lundbergii, Leptographium microsporum, Ophiostoma novo-ulmi, Ophiostoma piceae and Sporothrix spp.; Pezizomycetes such as Phymatotrichopsis omnivore and Polyscytalum pustulans; Phyllachorales such as Gibellina cerealis, Phyllachora maydis and Phyllachora pomigena; Amphisphaeriales such as Griphosphaeria corticola, Lepteutypa cupressi and Pestalotia rhododendri; Capnodiales such as Capnodium ramosum and Schizothyrium pomi; Chaetothyriales such as Phialophroa spp.; Cladosporiales such as Cladosporium species including Cladosporium oxysporum, Cladosporium cucumerinum and Cladosporium allii-cepae; Rhytismatales such as Lophodermium seditiosum and Naemacyclus spp.; Saccharomycetales such as Cephaloascus species including Cephaloascus fragrans; Geotrichum candidum, Candida species including Candida glabrata, Candida krusei, Candida lusitaniae, Candida parapsilosis, Candida albicans and Candida tropicalis; Sordariales such as Chaetomium spp. and Monosporascus cannonballus; Sordariomycetes such as Wongia garrettii and Wongia griffinii; Taphrinales such as Taphrina bullata and Taphrina deformans; Onygenales such as Ajellomyces capsulatus, Blastomyces dermatitidis, Coccidioides species including Coccidioides immitis; Epidermophyton spp., Histoplasma spp., Microsporum spp., Trichophyton spp., and Paracoccidioides species including Paracoccioides brasiliensis; and others such as Hymenula cerealis, Petriellidum spp., and Septocyta ruborum.
Basidiomycetes, including Pucciniales such as Cerotelium fici, Chrysomyxa arctostaphyli, Coleosporium ipomoeae, Cronartium ribicola, Gymnosporangium juniperi-virginianae, Gymnosporangium sabinae, Hemileia species including Hemileia vastatrix; Melampsora medusae, Melampsora lini, Phakopsora ampelopsidis, Phakopsora pachyrhizi, Phragmidium mucronatum, Puccinia species including Puccinia allii, Puccinia arachidis, Puccinia asparagi, Puccinia cacabata, Puccinia coronata, Puccinia graminis, Puccinia helianthi, Puccinia hieracii, Puccinia hordei, Puccinia horiana, Puccinia melanocephala, Puccinia polysora, Puccinia porri, Puccinia recondita, Puccinia sorghi, Puccinia striiformis, Puccinia striiformis f.sp. hordei, Puccinia striiformis f.sp. tritici and Puccinia triticina; Pucciniastrum coryli, Tranzschelia discolor, Uromyces species including Uromyces betae, Uromyces pisi and Uromyces viciae-fabae; Tilletiales such as Neovossia moliniae, and Tilletia species including Tilletia caries and Tilletia controversa; Ustilaginales such as Sporisorium reilianum and Ustilago species including Ustilago maydis, Ustilago segetum var. nuda, Ustilago segetum var. tritici and Ustilago striiformis; Urocystidales such as Urocystis species including Urocystis agropyri; Agaricales such as Marasmiellus inoderma, Mycena spp., Moniliophthora roreri and Moniliophthora perniciosa; Cantharellales such as Sclerotium spp. and Typhula species including Typhula incarnata and Typhula ishikariensis; Ceratobasidiales such as Waitea circinata, and Rhizoctonia species including Rhizoctonia cerealis, Rhizoctonia solani, Rhizoctonia theobromae and Rhizoctonia Zeae; Atheliales such as Athelia rolfsii; Corticiales such as Corticium invisum and Laetisaria fuciformis; Cystodilobasidiales such as Itersonilia perplexans; Entylomatales such as Entyloma calendulae f.sp. dahliae and Entylomella microspore; Exobasidiales such as Exobasidium vexans; Hymenochaetales such as Phellinus igniarius; Russulales such as Stereum hirsutum; and Tremellales such as Cryptococcus species including Cryptococcus neoformans. Zygomycetes, including Mucorales such as Choanephora cucurbitarum, Mucor spp., Rhizopus oryzae, Absidia corymbifera and Rhizomucor pusillus.
Blastocladiomycetes, including Physoderma maydis.
as well as diseases caused by other species and genera closely related to those listed above.

In addition to their fungicidal activity, the compositions may also have activity against diseases caused by Actinobacteria such as Streptomyces scabiei; Proteobacteria such as Erwinia amylovora, Pectobacterium carotovorum, Xanthomonas species including Xanthomonas axonopodis, Xanthomonas campestris, Xanthomonas citri, Xanthomonas oryzae and Xanthomonas vesicatoria; Xylella fastidiosa, and Pseudomonas species including Pseudomonas syringae; Cercozoa such as Polymyxa betae, Polymyxa graminis and Spongospora subterranea; and Bigyra such as Labyrinthula zosterae.

as well as diseases caused by other species and genera closely related to those listed above.

As a preferred embodiment of this invention, the compositions according to the present invention are particularly effective against pathogens belonging to Oomycetes class like downy mildews and late blights, in particular against pathogens of grapes, potatoes, tomatoes, cucurbits, leafy crops and tobacco. They are furthermore particularly effective against leafspot species and early blights; especially against Alternaria in potatoes, tomatoes, cucurbits, and black rot, red fire, powdery mildew, grey mold and dead arm disease in vine.

Preferably in the method of the present invention the phytopathogenic fungi are selected from the group consisting of Phytophthora infestans, Plasmopara viticola and Pseudoperonospora cubensis. More preferably, in the method of the present invention the phytopathogenic fungi are selected from the group consisting of Phytophthora infestans and Plasmopara viticola.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” is understood to denote generative parts of the plant, such as seeds, which can be used for the multiplication of the latter, and vegetative material, such as cuttings or tubers, for example potatoes. There can be mentioned for example seeds (in the strict sense), roots, fruits, tubers, bulbs, rhizomes and parts of plants. Germinated plants and young plants which are to be transplanted after germination or after emergence from the soil, may also be mentioned. These young plants can be protected before transplantation by a total or partial treatment by immersion. Preferably “plant propagation material” is understood to denote seeds.

The compositions according to the invention can be applied to the crop area or plant to be treated, simultaneously or in succession with further compounds. These further compounds can be e.g. fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation.

### EXAMPLES

The Examples which follow serve to illustrate the invention. The following examples demonstrate the effect on biological performance of compositions of the present invention; the adjuvants used are tabulated in Table A, along with comparative data for a composition comprising mandipropamid without an adjuvant.

TABLE A
Adjuvant description

| | | | CAS Registry |
|---|---|---|---|
| Component | Description | Adjuvant Class | Number |
| Emulsogen M | Alcohols, C16-18 and | Alcohol Alkoxylates | 68920-66-1 |
| (Emulsogen is a | C18- unsaturated, | | |
| trademark of Clariant) | ethoxylated (>5-9 EO) | | |
| Emulsogen MTP 070 | Alcohols C16-18, | Alcohol Alkoxylates | 68002-96-0 |
| (Emulsogen is a | ethoxylated + | | |
| trademark of Clariant) | propoxylated | | |
| Marlox RT 64 (Marlox is a | Alcohols C16-18, | Alcohol Alkoxylates | 68002-96-0 |
| trademark of Sasol) | ethoxylated + | | |
| | propoxylated | | |
| Genapol X 080 (Genapol is a | Alcohols C11-C14-iso-, | Alcohol Alkoxylates | 9043-30-5 |
| trademark of Clariant), also | C13 rich, ethoxylated, | | |
| known as ADUXOL TRD-08 | 8EO | | |
| Genapol X 060 (Genapol is a | Ethoxylated isotridecyl | Alcohol Alkoxylates | 78330-21-9 |
| trademark of Clariant) | alcohol, 6EO | | |
| Atlox MBA 11/8 (Atlox is a | Alcohol ethoxylate, | Alcohol Alkoxylates | 127036-24-2 |
| trademark of Croda) | mono-branched C11 | | |
| | with 8EO | | |
| Synperonic L11-SS-(CQ) | Fatty alcohol | Alcohol Alkoxylates | 68551-12-2 |
| (Synperonic is a trademark of | ethoxylate, C12/C14- | | |
| Croda) | 11EO | | |
| Plurafac LF 300 (Plurafac is a | Fatty alcohol alkoxylate | Alcohol Alkoxylates | n/a |
| trademark of BASF) | | | |
| Toximul 8320 (Toximul is a | Alcohols C4, | Alcohol Alkoxylates | 9038-95-3 |
| trademark of Stepan) | ethoxylated + | | |
| | propoxylated | | |
| Witconol NS500 (Witconol is | Alcohols C4, | Alcohol Alkoxylates | 85637-75-8 |
| a trademark of Evonik) | ethoxylated + | | |
| | propoxylated -34 | | |
| | PO/22 EO | | |
| Synperonic PE/L62 | Propylene- | Ethylene | 9003-11-6 |
| (Synperonic is a trademark of | oxide/ethylene-oxide | oxide/propylene | |
| Croda) | copolymer, approx. | oxide block | |
| | 20 wt % EO | copolymers | |
| Vinamul 18460 (Vinamul is a | ethylene vinylacetate | Polyacrylate | n/a |
| trademark of Celanese) | copolymer emulsion | Polymers | |
| Agnique PG8107-G (Agnique | Alkyl (C8/C10) | Alkyl Polyglycosides | 68515-73-1 |
| is a trademark of BASF) | polyglycoside | | |
| Synergen GA (Synergen is a | Alkyl (C8/C10) | Alkyl glucamides | 1591782-62-5 |
| trademark of Clariant) | glucamide | | |
| Agnique AE 829 (Agnique is | bis(7-methyloctyl) | bis(7-methyloctyl) | 166412-78-8 |
| a trademark of BASF) | cyclohexane-1,2- | cyclohexane-1,2- | |
| | dicarboxylate | dicarboxylate | |
| Tween 85 (Tween is a | Polyoxyethylene | Ethoxylated | 9005-70-3 |
| trademark of Croda) | sorbitan trioleate, 20 | Sorbitan Derivatives | |
| | EO units | | |
| Break-thru S-240 (Break-thru | Adjuvant based on | Polyether Modified | 134180-76-0 |
| is a trademark of Evonik) | polyether modified | Polysiloxanes | |
| | polysiloxane | | |

### PREPARATION EXAMPLES

### Example A1

Oil Dispersions (OD) of Mandipropamid were Prepared by the Following General Method:—

A portion of the methylated oil is weighed into a vessel, following this the dispersant and calcium salt of dodecylbenzenesulfonic acid (if present) are both weighed into the vessel under agitation. mandipropamid technical is then added, and a higher mixing speed is initiated and continued until a homogeneous suspension is obtained. This premix is then milled using a bead mill to achieve a particle size of 100% less than 50 m and greater than 70% less than 5 m as measured using laser diffraction particle size analyser.

The adjuvant (as herein defined) and any remaining components (except the viscosity modifying agents) are weighed into a vessel and homogenized. Any viscosity modifying agents are then weighed into the vessel, wetted into the formulation using moderate speed on the mixer and then mixing is completed using a higher speed. A homogeneous, smooth and viscous liquid is produced.

Compositions prepared using the above general method are given in Table 1 below.

### Example A2

Suspension Concentrates (SC) of Mandipropamid were Prepared by the Following General Method:

A portion of the water is weighed into a vessel, following this the dispersant and a portion of the antifoam, anti-settling agent and anti-bacterial agents are all weighed into the vessel under agitation. Mandipropamid technical is then added, and a higher mixing speed is initiated and continued until a homogenous suspension is obtained. This premix is then milled using a bead mill to achieve a particle size of 100% less than 50 m and greater than 70% less than 5 m as measured using laser diffraction particle size analyser.

The remaining water, antifoam, anti-settling agent and anti-bacterial agents are weighed into a vessel along with the anti-freeze agent, and hydrotrope (if present) and homogenized. The adjuvant(s) are then weighed into the vessel and homogenised, followed by the milled mandipropamid suspension. Mixing is completed using a low-shear mixer until a homogenous, smooth liquid is produced. Compositions prepared using the above general method are given in Table 1 below.

TABLE 1

| | | Example Number, (formulation type) and | | | | | | |
|---|---|---|---|---|---|---|---|---|
| | | Concentration (% w/v) | | | | | | |
| | | | F1 | F2 | F3 | F4 | F5 | F6 |
| Component | Role | Comp. | (OD) | (OD) | (OD) | (OD) | (SC) | (SC) |
| Mandipropamid | Active | 25 | 25 | 25 | 25 | 25 | 25 | 25 |
| | Ingredient | | | | | | | |
| Agrimer AL-22 (C16 | Dispersant | | 2.5 | | | | | |
| alkaylated | | | | | | | | |
| polyvinylpyrrolidone) | | | | | | | | |
| Altox 4912 (block | | | | 2.5 | 2.5 | 2.5 | | |
| copolymer of | | | | | | | | |
| polyhydroxystearic acid | | | | | | | | |
| and polyalkalyene | | | | | | | | |
| glycols) | | | | | | | | |
| Tersperse 2020 | | 2 | | | | | | |
| (naphthalenesulfonic acid | | | | | | | | |
| sodium salt condensed | | | | | | | | |
| with formaldehyde) | | | | | | | | |
| Atlox 4913 (solution of an | | | | | | | | 3 |
| acrylic graft copolymer in | | | | | | | | |
| water and | | | | | | | | |
| propyleneglycole | | | | | | | | |
| acrylic graft copolymer) | | | | | | | | |
| Agnique AE 829 | Adjuvant | | | | 15 | | | |
| Emulsogen M | | | 15 | 15 | | | | |
| Emulsogen MTP 070 | | | | | | 15 | | |
| Marlox RT 64 | | | | | | | 7.5 | |
| Atlox MBA 11/8 | | | | | | | | 7 |
| Synperonic L11-SS-(CQ) | | | | | | | | 15 |
| Aduxol TRD-08 | | | | | | | 7.5 | |
| (isotridecanol-8- | | | | | | | | |
| ethoxylate) | | | | | | | | |
| Genapol X-060 | | | | 5.5 | 5.5 | 5.5 | | |
| (ethoxylated isotridecyl | | | | | | | | |
| alcohol)X | | | | | | | | |
| Rhodacal 60/B-E | | | | 5.5 | 5.5 | 5.5 | | |
| (calcium dodecylbenzene | | | | | | | | |
| sulfonate, in 2- | | | | | | | | |
| ethylhexanol) | | | | | | | | |
| Alkamuls VO 2005 | Emulsifier | | | 3 | 3 | 3 | | |
| (ethoxylated castor oil, | | | | | | | | |
| oleate) | | | | | | | | |
| Eltesol AC 60 (cumol-x- | Hydrotrope | | | | | | 10 | |
| sulphonic acid | | | | | | | | |
| ammonium salt) | | | | | | | | |
| Propylene glycol | Anti-freeze | 10 | | | | | 10 | 10 |
| polydimethylsiloxane | Anti-foam | 0.5 | | | | | 0.25 | 1 |
| Aerosil 200 (colloidal | Viscosity | | 1 | | | | | |
| silica) | modifier | | | | | | | |
| Xanthan gum | | 0.3 | | | | | 0.25 | 0.02 |
| Montmorillonite clay | | 0.3 | | | | | 0.3 | 0.3 |
| Proxel GXL (1,2- | Biocide | 0.1 | | | | | 0.05 | 0.02 |
| benzisothiazol-3-one) | | | | | | | | |
| Agnique ME 18 RDF | Liquid Filler | | Rest | Rest | Rest | Rest | | |
| (rapeseed oil methyl | | | (56.5) | (46.5) | (46.5) | (46.5) | | |
| ester) | | | | | | | | |
| Water | | Rest | | | | | Rest | Rest |
| | | (61.8) | | | | | (39.15) | (38.66) |

Comp. = REVUS ® sold by Syngenta AG ® comprising mandipropamid as a suspension concentrate (SC) for the control of late blight in potatoes and downy mildew in a range of vegetable crops.

### BIOLOGICAL EXAMPLES

Mandipropamid (MPD) is a mandelamide fungicide belonging to the carboxyl acid amide group (FRAC 40). MPD is highly active against Oomycete fungi causing diseases such as late blight and downy mildews in a range of different crops. MPD fixes to the wax layers of plants from where small amounts penetrate into the plant tissue resulting in translaminar translocation. MPD prevents germination of zoospores and sporangia, inhibits mycelia growth and formation of haustoria and reduces sporulation.

### Example B1

The tables summarise data obtained from seven field trials. Independent research organizations carried out all tests under GEP (Good Experimental Practice) regime and according to EPPO (the European and Mediterranean Plant Protection Organization) methodology.

All of the trials assessed the efficacy against foliage Phytophthora infestans as pest severity (PESSEV) on leaf, plot, plant or stem (% area infected were 0%=no damage, 100%=complete dead crop) at regular times after each application on a one value per plot basis. Average was then calculated on the chosen assessments. In the tables, CHECK is reported as % of pest severity while tested prototypes as % of efficacy calculated according to the Abbot formula.

TABLE B1-1
Summary Average % Control across 7 trials against Phytophthora
infestans in potatoes at 0.6 L/HA; % area per plot

| | Labels | | | | | |
|---|---|---|---|---|---|---|
| | CHECK | Comp. | F1 | F2 | F3 | F4 |
| | (PESSEV) | 0.6 l/ha | 0.6 l/ha | 0.6 l/ha | 0.6 l/ha | 0.6 l/ha |
| Average | 99.9 | 69.0 | 83.5 | 83.6 | 86.6 | 88.0 |

TABLE B1-2
Summary Average % Control across 7 trials against Phytophthora
infestans in potatoes at 0.3 L/HA; % area per plot

| | Labels | | | | | |
|---|---|---|---|---|---|---|
| | CHECK | Comp. | F1 | F2 | F3 | F4 |
| | (PESSEV) | 0.3 l/ha | 0.3 l/ha | 0.3 l/ha | 0.3 l/ha | 0.3 l/ha |
| Average | 99.9 | 45.9 | 57.7 | 58.7 | 61.0 | 63.7 |

The results clearly show that formulations F1 to F6 provide surprisingly improved control against Phytophthora infestans when compared with the existing commercial standard formulation Revus®.

### Example B2

The tables below summarise data obtained from field trials at a number of different locations. Sequential applications of the same product were conducted on plots from 14.4 to 285 m². Applications start in a preventative way previous to the start of the fast growing period of the crop.
Maintenance applications were conducted before the start of treatment applications in all plots with Multisites fungicides to ensure preventative applications.
Calendar of applications were followed with the same product to avoid any interference on the result.

The application interval was different depending on the treatments to evaluate the difference of the formulations in 2 conditions:
Short intervals: 5-7 days between applications
Long intervals: 10-12 days between applications

The application method was foliar spraying with manual or tractor mounted horizontal boom sprayer:
The water volume used was the amount able to cover all the crop canopy by spraying whilst avoiding runoff from the foliar surfaces: the range of water volume used was from 150-300 L/ha.
Application pressure ranged between 2 and 3.2 bar depending on the equipment used.

The trial design was randomized complete block with 4 replicates of each treatment.

Assessments were conducted by expert triallist evaluating the plot as a whole rating the % of leaves covered by Phytophthora infestans symptoms
Table given by EPPO Guideline PP 1/2(4) (scale: 0, 1, 5, 10, 25, 50, 100 percent diseased area) were used as reference but intermediate values were also used.

TABLE B2-1
Summary % Control against Phytophthora infestans in potatoes,
6 Trials Over 30% Severity: 5 To 7 Days Interval

| | | | | | | | | | Av. % |
|---|---|---|---|---|---|---|---|---|---|
| | | L1 | L2 | L3 | L4 | L5 | L6 | | Difference |
| Trial | | % | % | % | % | % | % | Av. % | with |
| No. | Treatment | Control | Control | Control | Control | Control | Control | Control | Revus |
| T1 | Untreated | 0.0 | 0.0 | 0.0 | 0.0 | 0.0 | 0.0 | 0.0 | |
| | (Pest | | | | | | | | |
| | severity) | | | | | | | | |
| T2 | Comp. (5- | 50.7 | 71.3 | 69.7 | 93.2 | 92.5 | 89.3 | 77.8 | 0.0 |
| | 7 day) | | | | | | | | |
| T3 | F5 | 60.6 | 83.8 | 72.0 | 93.3 | 93.8 | 96.8 | 83.4 | 5.6 |
| | (5-7 day) | | | | | | | | |
| T4 | F6 | 60.6 | 83.3 | 85.6 | 86.0 | 93.8 | 94.4 | 83.9 | 6.1 |
| | (5-7 day) | | | | | | | | |
| T5 | F1 | 73.2 | 96.0 | 72.7 | 93.3 | 93.8 | 95.3 | 87.4 | 9.6 |
| | (5-7 day) | | | | | | | | |

Trial Location:
L1 = Les Barges, CH
L2 = Bretagne, FR
L3 = Les Crespys, FR
L4 = Lelysted, NL
L5 = Lelysted, NL
L6 = BE

TABLE B2-2
Summary % Control 6 Trials Over 30% Severity: 10 To 12 Days Interval

| | | | | | | | | | Av. % |
|---|---|---|---|---|---|---|---|---|---|
| | | | | | | | | Av. % | Difference |
| Trial | | | | | | | | Control | with |
| No. | Treatment | L1 | L2 | L3 | L4 | L5 | L6 | (sev) | Revus |
| T1 | Untreated | 0.0 | 0.0 | 0.0 | 0.0 | 0.0 | 0.0 | 0.0 | |
| | (Pest | | | | | | | | |
| | severity) | | | | | | | | |
| T6 | Comp. | 62.0 | 23.8 | 69.7 | 95.0 | 85.0 | 86.7 | 70.3 | 0.0 |
| | (10-12 | | | | | | | | |
| | day) | | | | | | | | |
| T7 | F5 (10-12 | 62.0 | 45.0 | 82.6 | 96.0 | 81.3 | 94.0 | 76.8 | 6.4 |
| | day) | | | | | | | | |
| T8 | F6 (10-12 | 62.0 | 38.8 | 71.2 | 91.7 | 85.0 | 94.7 | 73.9 | 3.5 |
| | day) | | | | | | | | |
| T9 | F1 (10-12 | 76.1 | 70.0 | 68.2 | 93.3 | 88.8 | 97.7 | 82.3 | 12.0 |
| | day) | | | | | | | | |

The results clearly show that formulations F1, F5 and F6 provide surprisingly improved control against Phytophthora infestans when compared with the existing commercial standard formulation Revus® (Comp.) shown as the Av. (average) % increase over Revus® as % points increase.

### Example B33: Greenhouse Trial in Tomatoes with Different Adjuvants Showing Increase in Performance in Comparison with the Revus Formulation

Tomato plants var. roter Gnom were grown in pots and applied with different treatments through a track sprayer with a spray volume that ensure the proper coverage of the plant avoiding the run off over the leaves surface. The day after the application, plants were inoculated with a spore suspension of the fungus and then placed in the proper conditions to facilitate the fungal development. Plants were assessed for the fungal development at 4 days after the inoculation. Preventative fungicidal activity and efficacy in the control of the disease are shown in tables B3-1 and B3-2 below, wherein R1, R2 and R3 refer to repeat experiments and the % increase over Revus® is % points increase.

TABLE B3-1
Summary % Control of Phytophthora infestans in Tomato at 60 mg/L

| | | | | | | | % |
|---|---|---|---|---|---|---|---|
| | | Pest Severity on Plants | | | | | Increase |
| | Rate | Without Rain (%) | | | | % | over |
| Treatment | (mg/L) | R1 | R2 | R3 | Average | Efficacy | Revus ® |
| Check (untreated control) | | | | | 85 | | |
| Revus (Comp.) | 60 | 60 | 75 | 75 | 70 | 18 | 0 |
| Revus + 0.5% Vinamul 18460 | 60 | 65 | 65 | 75 | 68 | 20 | 2 |
| Revus + 0.1% Synperonic L11 | 60 | 3 | 5 | 5 | 4 | 95 | 77 |
| and Atlox MBA 11/8 | | | | | | | |
| Revus + 0.05% Synperonic L11 | 60 | 15 | 20 | 20 | 18 | 79 | 60 |
| and Atlox MBA 11/8 | | | | | | | |
| Revus + 0.025% Synperonic L11 | 60 | 25 | 30 | 30 | 28 | 67 | 49 |
| and Atlox MBA 11/8 | | | | | | | |
| Revus + 0.1% APG (Agnique | 60 | 30 | 40 | 30 | 33 | 61 | 43 |
| PG8107-G) | | | | | | | |

TABLE B3-2
Summary % Control of Phytophthora infestans in Tomato at 600 mg/L

| | | | | | | | % |
|---|---|---|---|---|---|---|---|
| | | Pest Severity on Plants | | | | | Increase |
| | Rate | Without Rain (%) | | | | % | over |
| Treatment | (mg/L) | R1 | R2 | R3 | Average | Efficacy | Revus ® |
| Check (untreated control) | | | | | 85 | | |
| Revus Comp. | 600 | 60 | 65 | 60 | 62 | 28 | 0 |
| Revus + 0.5% Vinamul 18460 | 600 | 50 | 60 | 50 | 53 | 38 | 10 |
| Revus + 0.1% Synperonic L11 | 600 | 2 | 3 | 3 | 3 | 97 | 69 |
| and Atlox MBA 11/8 | | | | | | | |
| Revus + 0.05% Synperonic L11 | 600 | 15 | 10 | 10 | 12 | 86 | 59 |
| and Atlox MBA 11/8 | | | | | | | |
| Revus + 0.025% Synperonic L11 | 600 | 20 | 20 | 20 | 20 | 77 | 49 |
| and Atlox MBA 11/8 | | | | | | | |
| Revus + 0.1% APG (Agnique | 600 | 15 | 20 | 15 | 17 | 80 | 53 |
| PG8107-G) | | | | | | | |

### Example B4: Greenhouse Trial in Tomatoes with Different Adjuvants Showing Increase in Performance in Comparison with the Revus® Formulation

Tomato plants var. roter Gnom was grown in pots and applied with different treatments through a track sprayer with a spray volume that ensure the proper coverage of the plant avoiding the run off over the leaves surface. The day after the application, plants were inoculated with a spore suspension of the fungus and then placed in the proper conditions to facilitate the fungal development. Plants were assessed for the fungal development at 10 days after the inoculation. Preventative fungicidal activity and efficacy in the control of the disease are shown in tables B4-1 and B4-2 below, wherein R1, R2 and R3 refer to repeat experiments and the % increase over Revus® is % points increase.

TABLE B4-1
Summary % Control of Phytophthora infestans in Tomato at 60 mg/L

| | | | | | | | % |
|---|---|---|---|---|---|---|---|
| | | Pest Severity on Plants | | | | | Increase |
| | Rate | Without Rain (%) | | | | % | over |
| Treatment | (mg/L) | R1 | R2 | R3 | Average | Efficacy | Revus ® |
| Check (untreated control) | | | | | 100 | 0 | |
| Revus in water | 60 | 80.0 | 85.0 | 80.0 | 81.7 | 18.3 | 0.0 |
| Revus in Synperonic/Atlox (0.1%) | 60 | 10.0 | 15.0 | 15.0 | 13.3 | 86.7 | 68.3 |
| Revus in Genapol X080 + | 60 | 10.0 | 10.0 | 5.0 | 8.3 | 91.7 | 73.3 |
| Witconol NS500 (1:1) | | | | | | | |
| Revus in Agnique PG8107-G + | 60 | 20.0 | 25.0 | 25.0 | 23.3 | 76.7 | 58.3 |
| Witconol NS500 (0.1%) | | | | | | | |
| Revus in Synergen OS (0.1%) | 60 | 45.0 | 30.0 | 30.0 | 35.0 | 65.0 | 46.7 |
| Revus in Synergen GA (0.1%) | 60 | 40.0 | 30.0 | 40.0 | 36.7 | 63.3 | 45.0 |
| Revus in Resinoline BD 25 (0.1%) | 60 | 90.0 | 75.0 | 70.0 | 78.3 | 21.7 | 3.3 |
| Revus in Break-Thru S-240 | 60 | 30.0 | 30.0 | 30.0 | 30.0 | 70.0 | 51.7 |
| (0.1%) | | | | | | | |
| Revus in Tween 85 + Toximul | 60 | 30.0 | 30.0 | 25.0 | 28.3 | 71.7 | 53.3 |
| 8320 + Atlox 4913 1:1:1 (0.1%) | | | | | | | |
| Revus in Marlox RT64 (0.1%) | 60 | 20.0 | 20.0 | 20.0 | 20.0 | 80.0 | 61.7 |
| Revus in Marlox RT64 + APG | 60 | 20.0 | 20.0 | 10.0 | 16.7 | 83.3 | 65.0 |
| (Agnique PG8107-G) (0.1%) | | | | | | | |
| Revus in Sodium dodecylbenzene | 60 | 30.0 | 35.0 | 25.0 | 30.0 | 70.0 | 51.7 |
| sulfonate + 12.5% IPA (0.1%) | | | | | | | |

TABLE B4-2
Summary % Control of Phytophthora infestans in Tomato at 600 mg/L

| | | | | | | | % |
|---|---|---|---|---|---|---|---|
| | | Pest Severity on Plants | | | | | Increase |
| | Rate | Without Rain (%) | | | | % | over |
| Treatment | (mg/L) | R1 | R2 | R3 | Average | Efficacy | Revus ® |
| Check (untreated control) | | | | | 100 | 0 | |
| Revus in water | 600 | 90.0 | 60.0 | 40.0 | 63.3 | 36.7 | 0.0 |
| Revus in Synperonic/Atlox (0.1%) | 600 | 2.0 | 10.0 | 10.0 | 7.3 | 92.7 | 56.0 |
| Revus in Genapol X080 + | 600 | 5.0 | 5.0 | 10.0 | 6.7 | 93.3 | 56.7 |
| Witconol NS500 (1:1) | | | | | | | |
| Revus in Agnique PG8107-G + | 600 | 10.0 | 10.0 | 15.0 | 11.7 | 88.3 | 51.7 |
| Witconol NS500 (0.1%) | | | | | | | |
| Revus in Synergen OS (0.1%) | 600 | 30.0 | 20.0 | 20.0 | 23.3 | 76.7 | 40.0 |
| Revus in Synergen GA (0.1%) | 600 | 20.0 | 15.0 | 20.0 | 18.3 | 81.7 | 45.0 |
| Revus in Resinoline BD 25 (0.1%) | 600 | 30.0 | 35.0 | 30.0 | 31.7 | 68.3 | 31.7 |
| Revus in Break-Thru S-240 | 600 | 5.0 | 10.0 | 10.0 | 8.3 | 91.7 | 55.0 |
| (0.1%) | | | | | | | |
| Revus in Tween 85 + Toximul | 600 | 20.0 | 20.0 | 20.0 | 20.0 | 80.0 | 43.3 |
| 8320 + Atlox 4913 1:1:1 (0.1%) | | | | | | | |
| Revus in Marlox RT64 (0.1%) | 600 | 5.0 | 5.0 | 3.0 | 4.3 | 95.7 | 59.0 |
| Revus in Marlox RT64 + APG | 600 | 3.0 | 5.0 | 10.0 | 6.0 | 94.0 | 57.3 |
| (Agnique PG8107-G) (0.1%) | | | | | | | |
| Revus in Sodium dodecylbenzene | 600 | 20.0 | 20.0 | 20.0 | 20.0 | 80.0 | 43.3 |
| sulfonate + 12.5% IPA (0.1%) | | | | | | | |

1. A composition comprising,
(i) mandipropamid; and
(ii) one or more adjuvants selected from the group consisting of alcohol alkoxylates, ethylene oxide/propylene oxide block copolymers, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate; and wherein the composition is an oil dispersion.

2. The composition according to claim 1, wherein the one or more adjuvants are selected from the group consisting of alcohol alkoxylates, ethylene oxide/propylene oxide block copolymers, sodium dodecylbenzene sulfonate, calcium dodecylbenzene sulfonate, potassium dodecylbenzene sulfonate and bis(7-methyloctyl) cyclohexane-1,2-dicarboxylate.

3. The composition according to claim 1, wherein the one or more adjuvants are selected from the group consisting of C₁₆-C₁₈ alcohol alkoxylates, sodium dodecylbenzene sulfonate, calcium dodecylbenzene sulfonate, potassium dodecylbenzene sulfonate and bis(7-methyloctyl) cyclohexane-1,2-dicarboxylate.

4. The composition according to claim 1, wherein the alcohol alkoxylate adjuvant comprises a C₁₆-C₁₈ straight or branched chain alkyl or alkenyl group and from 4 to 9 propylene oxide [PO] and from 4 to 15 ethylene oxide [EO] units.

5. The composition according to claim 1, wherein the mandipropamid:adjuvant w/v ratio is from about 1:0.1 to 1:20.

6. The composition according to claim 1, further comprising at least one additional active ingredient.

7. The composition according to claim 1, wherein the oil is a vegetable oil.

8. The composition according to claim 1, wherein the oil is a C₁-C₆alkyl ester of a vegetable oil.

9. The composition according to claim 1, wherein the oil is a rapeseed oil methyl ester.

10. The composition according to claim 1, wherein the one or more adjuvants are built-in to the composition.

11. A composition comprising,
(i) mandipropamid; and
(ii) one or more adjuvants selected from the group consisting of C₁₀-C₁₈ alcohol alkoxylates and bis(7-methyloctyl) cyclohexane-1,2-dicarboxylate.

12. The composition according to claim 11, wherein the alcohol alkoxylate adjuvant comprises a C₁₀-C₁₈ straight or branched chain alkyl or alkenyl group and from 0 to 10 propylene oxide [PO] and from 2 to 20 ethylene oxide [EO] units.

13. A method of controlling or preventing infestation of useful plants by phytopathogenic fungi comprising applying a composition according to claim 1, to said plants, to parts thereof or the locus thereof.

14. A method according to claim 13, wherein the phytopathogenic fungi are selected from the group consisting of Phytophthora infestans, Plasmopara viticola and Pseudoperonospora cubensis.

15. Use of one or more adjuvants selected from the group consisting of ethylene oxide/propylene oxide block copolymers, alcohol alkoxylates, polyacrylate polymers, alkyl polyglycosides, alkyl glucamides, ethoxylated sorbitan derivatives, polyether modified polysiloxanes, sodium dodecylbenzene sulfonate, calcium dodecylbenzene sulfonate, potassium dodecylbenzene sulfonate, tris(2-ethylhexyl) phosphate and bis(7-methyloctyl) cyclohexane-1,2-dicarboxylate to improve the biological performance of mandipropamid.
